(19) United States
(12) Patent Application Publication
(10) Pub. No.: US 2010/0274682 A1
(43) Pub. Date: Oct. 28, 2010

(54) DISTRIBUTED PURCHASING SYSTEM

(76) Inventor: Umesh Pai, Sydney (AU)

Correspondence Address: UMESH PAI;ROHIT DESHPANDE, 102 SHREE VIDYANAND, DR KETKAR ROAD ERANDWANE, PUNE, 411004, IN

(21) Appl. No.: 12/809,591

(22) PCT Filed: Dec. 18, 2008
(86) PCT No.: PCT/IB08/55420

§ 371 Date: Jun. 20, 2010

(30) Foreign Application Priority Data
Dec. 20, 2007 (AU) 2007907011

(51) Int. Cl. G06Q 30/00

(52) U.S. Cl. 705/26

(57) ABSTRACT

A distributed purchase system for commerce transactions comprising essentially a plurality of databases communicatively connected to an internet network over which providers and customers can communicate anonymously with an intention of completing a provision of products (which could be a commercial transaction). The communication software having inbuilt tools for synergistic enablement of maintenance of secure access control, user authentication, parsing of user information and filtering of this data in accordance with the requisition details to arrive at best bid and issuance of user alerts using various communication devices to the corresponding parties comprising the best bid.

### FIELD OF THE INVENTION

The present invention relates generally to computer based purchasing systems, and particularly to systems for making online purchases having providers and requestors distributed across a communications network.

### BACKGROUND

The proliferation of service providers of both goods and services is both an opportunity and a problem for their potential customers. The Opportunity arises from the fact that the potential customer typically has a large potential pool of providers, which presents opportunities for competitive quoting between providers with subsequent benefits to the customer. However, in practice if the customer wishes to obtain competitive quotes, he needs to identify a number of suitable service providers and get comparative quotes. This is time consuming and often frustrating, because one or more of the service providers he identifies may not service the area in which the customer needs the service, or may not serve customers of the customers size and so on.

Computer systems as tools to aid purchase transactions is not a new concept. Conventional point-of-sale computer systems, such as those used in retail stores to record transactions, have played limited roles in purchase relationship management as their primary applicability lies not in utilization of their processing capacities for selection of the best deal for parties to a purchase transaction, but as mere memory registers for recording the transactions for accounting and data archival.

Dynamics of the global economies in the last few decades have evolved a generation of providers and requesters who, in light of the alternatives available to either, would prefer comparing between available choices before selection and execution of their purchase transactions. Advent of consumerism has rendered services including medical aid to be considered as typical purchase transactions. However, it would be easily appreciated that the logic that goes into arriving at the best deal for a purchase transaction would depend on a large plurality of qualitative and quantitative parameters the correct selection and comparative evaluation of which is absolutely critical to arriving at the best combination of provider and the customer.

The growth of electronic commerce (e-commerce) over the Internet has been explosive, and expectations are that such growth will continue. However, the Internet as an open network provides opportunities to legally and illegally collect and use vast amounts of information which people consider private and personal, and concerns over privacy, fraud and security online could inhibit the continued explosive growth of business-to-consumer electronic commerce. Currently, shopping, browsing or other information-sharing activities on the Internet exposes users to unwanted collection of their private and personal information, from which their identities, activities, behaviors and preferences can be ascertained. Thus, to map market performance from the past transaction behavior of a market player, while maintaining absolute anonymity as to the personal details, is a concept worth utilization for true assessment of reliability in future transactions.

Considering the vast range of market choices available in respect of vendibles, offerers and offerees, it is a pressing need of the field for development of a transparent interface for capturing the real-time landscape of provider, vendees, offers, requisitions and inventory management and subsequently enabling the logic for evaluation of best combination of provider and vendee and communicating to the respective parties the occurrence of such an event. Also, risk of fraudulent transactions, accurate authentication of parties and removing biases other than market performance in influencing the transactions are some other problems that remain to be addressed. The present inventors have attempted to address these and other related problems of art.

### RELATED ART

Attempts at addressing the said problems find mention in the art. Some of the notable attempts are:
U.S. Pat. No. 6,801,819
U.S. Pat. No. 7,010,504
U.S. Pat. No. 5,758,328
U.S. 60/169,538
U.S. Pat. No. 6,647,373

U.S. Pat. No. 6,801,819 discloses a method for scheduling a resource for processing a workpiece—the said method includes defining a commitment window specifying a time period required for processing the workpiece. A plurality of candidate bids having candidate commitment windows within the commitment window with varying start times, end times and candidate commitment window sizes is generated. A cost for each of the plurality of candidate bids is determined. A flexibility discount is applied to the cost of the candidate bid. Each candidate bid is evaluated in accordance with an objective function. A candidate bid is selected for scheduling the resource based on the objective function evaluation. A system includes a resource for processing a workpiece and at least one scheduling agent. The scheduling agent is configured to define a commitment window having a kernel specifying a time period required for processing the workpiece, generate a plurality of candidate bids having candidate commitment windows with varying start times, end times and candidate commitment window sizes, determine a cost for each of the plurality of candidate bids, apply a flexibility discount to the cost of the candidate bid, evaluate each candidate bid in accordance with an objective function, and select a candidate bid for scheduling the resource based on the objective function evaluation. However, this method lacks enablement of logic for evaluation of transaction behavior of a particular party to the transaction and using the same to influence future transactions by said party. The task scheduling and transaction management system outlined by this invention is static in nature and thus, cannot capture dynamics of the market situation and rank the players according to their performance indices.

U.S. Pat. No. 7,010,504 discloses a system of bid evaluation via best price as critical parameter. The system functions by comparing bidding prices per unit volume and utilization efficiencies of resources in the past by a provider. This invention suffers from the drawback that only bidding price is selected as critical factor for influencing decision as to freezing of the transaction deal. Irrespective of whether the bids are revisable or not, the system of bid evaluation proposed by this patent does not provide for assessment of true affordability and plausibility of the transaction deal taking into account the factors of logistics, delivery alternatives and the like. Thus, the evaluation of the best bid, in accordance with principles of the present invention does not suffice the said problems of art.

U.S. 60/169,538 outlines an online trading system including a Bid/Offer input interface for allowing users to enter the terms of bids or offers for posting in the system anonymously without identification of the submitter. While this approach is beneficial in removing biases other than professional performance of a market player, this system does not provide for a memory of performance as an indice for ranking the said market player and influencing his credibility for future transactions. Thus, the system lacks the concept of incentive for good performance—a necessity in maintenance of performance quality levels in the market.

U.S. Pat. No. 5,758,328 describes a computer system forming a computer based communications network of network members inclusive of network buyers and or network providers for processing requests for quotation for products through at least one central processing unit including operating system software for controlling the identification of network members, means for network buyers to generate request for quotation for products, means for transmitting said request for quotation to said central processing unit, filter means for selecting appropriate network members to receive said request for quotation based on filter conditions defined by the buyer in said request for quotation and/or by the provider and/or by the central processing unit, means for broadcasting said request for quotation to the network members selected by said filter means and means for responding to the generator of said request quotation with either a response to said, request for quotation or with a list of said selected network members. Filter conditions may define the class of providers in terms of geographical location, quantity, language spoken, currency, special conditions of sale, and the like.

U.S. Pat. No. 6,647,373 provides, in a computer network enabling communication between a host computer and a plurality of remote bidders, or between a peer computer and a plurality of peer bidders, a system and method for transmitting and processing reverse auction information implemented as a computer program within the network and the computers on which the program operates, comprising posting means for posting information across the network, the information being descriptive of a request and/or specification of goods and services to be purchased, bidding means available to the bidders for submitting a plurality of proposals across the network in response to the request and/or specification, the bids including financial information, a description of the goods and services to be provided, information about the bidder including one or more pointers to bidder addresses such as an email address and a World Wide Web address, receiving means for receiving the plurality of bids sent across the network by a plurality of proposers, security means for allowing access to only designated request and bid information by those with authorized access, evaluation means for ranking bids received in accordance with financial and an unspecified number of other qualitative and quantitative dimensions, and displaying means for providing relevant information to requestors and to bidders

The above-mentioned prior arts neither identify nor anticipate the present invention. The inflexibility of these methods along with their limited outreach to all potential transaction environments has been largely limited, thus making the present invention both novel and containing inventive step.

None of the above inventions and patents, taken either singularly or in combination, is seen to describe the instant invention as claimed. Thus a method and system for transacting e-commerce and related data management, analysis, & reporting solving the aforementioned problems is desired.

### SUMMARY

It is an object of the present invention to substantially overcome, or at least ameliorate, one or more disadvantages of existing arrangements.

Disclosed are arrangements, referred to as Goods and Service Provision Portal (GSPP) arrangements, which seek to address the above problems by (a) broadcasting, substantially simultaneously using electronic communication technology, a job specification provided by the potential customer (referred to as a “requestor”) to a population of potential service providers (referred to as “providees”), (b) processing the provider responses (referred to as “bids”) in an automatic or semi-automatic manner, (c) selecting one of the bids as best fitting criteria specified by the requestor, and (d) advising both the requestor and the provider of the successful bid.

According to a first aspect of the present invention, there is provided a computer based method of selecting a service provider, the method comprising the steps of:

providing by a requestor a job description to a GSPP portal;

broadcasting by the GSPP portal a substantially simultaneous invitation based upon the job description to a population of providers over a communications network;

communicating by at least some of the providers corresponding bids to the GSPP portal in respect of the invitation;

ranking by the GSPP portal the bids according to the job description;

selecting based upon the ranked bids a suitable bid; and

advising the requestor of the selected bid and the corresponding provider.

According to another aspect of the present invention, there is provided a system for selecting a service provider, the system comprising:

a memory for storing a program; and

a processor for executing the program, said program comprising:

code for providing by a requestor a job description to a GSPP portal;

code for broadcasting by the GSPP portal a substantially simultaneous invitation based upon the job description to a population of providers over a communications network;

code for communicating by at least some of the providers corresponding bids to the GSPP portal in respect of the invitation;

code for ranking by the GSPP portal the bids according to the job description;

code for selecting based upon the ranked bids a suitable bid and a corresponding provider; and

code for advising the requestor of the selected bid and the corresponding provider.

According to another aspect of the present invention, there is provided a computer program product including a computer readable medium having recorded thereon a computer program for directing a processor to execute a method for selecting a service provider, the program comprising:

code for providing by a requestor a job description to a GSPP portal;

code for broadcasting by the GSPP portal a substantially simultaneous invitation based upon the job description to a population of providers over a communications network;

code for communicating by at least some of the providers corresponding bids to the GSPP portal in respect of the invitation;

code for ranking by the GSPP portal the bids according to the job description;

code for selecting based upon the ranked bids a suitable bid and a corresponding provider; and

code for advising the requestor of the selected bid and the corresponding provider.

Other aspects of the invention are also disclosed.

The invention disclosed herein relates to transactions over a communications network between first and second parties where the first party may be a consumer or retail customer and the second party may be a merchant or retailer. Transactions include ordering of products and/or delivery and payment for the same while securing private and personal information specific to the first party or the network device used by the first party with respect to the second party and unauthorized parties, i.e., others who may or may not be parties to the transaction. Such information may include the first party's identity, financial information (where a purchase is involved) and address. The product may be delivered to a physical address or electronic address designated by the first party or to a physical depot for pick-up by the first party, while providing complete anonymity of the first party with respect to the second party. An aspect adding to the novelty of the present invention is that the requestor and seller are both advised as to the best bid by mapping their resource costs, availability and ability to deliver by making use of a customized online portal. The present invention therefore provides a novel system and method for enabling online purchasing making use of novel surface interfaces. Other aspects of the present invention are also disclosed.

### BRIEF DESCRIPTION OF THE DRAWINGS

One or more embodiments of the present invention will now be described with reference to the drawings and appendices, in which:

FIG. 1 shows a functional block diagram for a system upon which the goods and services provision (GSPP) arrangements can be provided;

FIG. 2 depicts functional elements in the call centre of FIG. 1;

FIG. 3 shows an arrangement of functional modules that form part of the GSPP portal in FIG. 1;

FIG. 4 is a functional block diagram of a general-purpose computer system upon which GSPP arrangements described can be practiced;

FIG. 5 is a flowchart showing a process of how the GSPP arrangement operates in one example;

FIG. 6A shows a flowchart for a process by which a new provider can register with the GSPP system;

FIG. 6B shows a flowchart for a process by which a new requestor can register with the GSPP system; and

APPENDICES A-C show spreadsheet examples of how the GSPP arrangements can be implemented using spreadsheets.

### OBJECTS OF THE PRESENT INVENTION

It is the primary object of the present invention to provide for a transparent online interface and software for market players that comprises means for selecting the best bid among a plurality of bids chosen in response to requisition by potential customer

It is another object of the present invention to provide for an electronic repository for secure storage of user data with user authentication and access control.

It is a further object of the present invention to provide for software tools for monitoring market performance of users and using the data thereof for updating parameter weightage instrumental in arriving at the best bid for potential customers

It is a further object of the present invention to provide selectibility of evaluation parameters to potential customers for identifying best suitable bid for the transaction without revealing identity of parties involved till stage of signing of contract

It is another object of the invention to reduce the unwanted collection and/or dissemination of information related to users of a communications network, particularly an open communications network.

It is another object of the invention to store information relating to electronic purchases of products by requestors from providers and provide an indice for the purpose of determining the performance of the providers and requestors.

It is a further object of the present invention to integrate common art communication means for enablement of communication network between market players

It is another object of the invention to gather information about electronic transactions and purchases that does not include private and personal information of requestors, but includes other information about the transaction, including information about the product, its price, and the identity of the electronic provider.

It is another object to provide a database, which stores such information such that requestors and providers are anonymous in the database.

It is another object of the invention to provide such a system and software for the electronic purchase of a product over a communications network which can be selectively configured to provide certain transaction information including requisition and offer details, customized user alerts and the like to parties of the transaction while securing the first party's private and personal information with respect to the second party and unauthorized parties.

It is a further object of the present invention to substantially overcome, or at least ameliorate, one or more disadvantages of the existing arrangements disclosed in the art while saving on operational costs and time in a purchase transaction.

### DETAILED DESCRIPTION OF THE PRESENT INVENTION

In the preferred embodiment, the invention is configured to work with the webpage networked computer system, a detailed overview of which follows. It will be appreciated that not every implementation will necessarily embody all or even most of the specific details and extensions discussed below in relation to the basic system. However, the system is described in its most complete form to reduce the need for external reference when attempting to understand the context in which the preferred embodiments and aspects of the present invention operate.

An aspect of the present invention is the concept of search optima. The reference data for products is taken from the Standards body of respective country of implementation. This serves in the setting up of standards of market acceptability and compliances that need to be through for a provider to be present in the system. Thus, maintaining a baseline for quality standards in accordance with the governing legislations. However, while registering, the providers are given option to choose one or more keywords that could best describe their nature of products. These keywords are linked to the provider along with the reference. Therefore, whenever a requestor searches for a provider, he has the option to use keywords search as well as category wise, tree-structure wise search. This serves to reduce the time a search operation takes to get the first set of results. Also, search will be further optimized to search for products for which the providers have registered, rather than the entire reference data. In addition, the user will have the option to expand or narrow search based on locality and other possible attributes (Advanced Search).

According to another aspect of the present invention, common art communication networks are used to advantage for sending quote request though computer (Internet enabled) or Landline (via Call Center Agent), issue alerts sent to Providers through SMS broadcast & Computer (Internet enabled) modalities and communicate Providers' Response (with Estimates/Quotes) by either computer enabled modalities or Mobile Phone/Landline (Internet/SMS/Call Center/IVR).

According to one aspect of the present invention, the distributed purchase system offers a choice to the requestor for selecting his transaction partner. Thus, if the requestor has a preferred supplier or a list of such, he may direct his request only to those in the list and choose (a) not to call anyone else or (b) if the preferred Provider(s) fail to respond within a given time, to send the request to all other eligible providers to bid

Another aspect of the present invention is to provide means for automated ranking of bids. This exercise mandates parsing of data pertaining to users, inventory and history of past transactions and further, selection of definitive indices according to filters chosen according to user requisition.

Quick and automatic determination of winning bids is enabled by providing a balance between up to four possible parameters: cost, quality of product, time, logistical distance where the weightage given to each parameter is automatic (by default) or selected by the requestor by a slider GUI (for example: low/med/high). This is an objective method and a transparent process—(from quote request to bid selection).

The parameters mentioned in the preceding paragraph are chosen in a systematic manner. Pecuniary costs are decided by the provider once the specifications or the task requirements are clear. Recordal of this data-value occurs when the provider provides a quotation for the given task.

The quality factor (Q-Factor) is available from provider database populated in accordance with the acceptability standards of the region and feedbacks from previous transactions. The urgency factor is calculated from the time of arrival/delivery as given (in the bid) by Provider. This depends on the urgency of delivery desired by the requestor and it s performance subjective to availability and ability of the provider to deliver within the said time frame. Proximity Factor is calculated from the geo-codes of Requestor and Provider address. This may be obtained from requisite fields of the database of registered users of the system.

The present invention provides for default logic of giving weightage to the above-mentioned parameters. The parameters of costs and quality come into play as inversely proportional factors. The parameter of urgency comes into play only when the job/service is marked as urgent (for example, within the next 4 hours of call). The factor of proximity comes into play when the customer has to take delivery/visit the provider and the logistics determine the speed and costs of said delivery. Thus, it may be generally contended that the four parameters chosen serve to function in a faultless manner in all circumstances of user selectable requisitions to ably shortlist the providers matching the said filters, instead of performing the time consuming task of comparative selection among the entire list of providers. Appropriate weightage in the form of coefficients is given to the above parameters based on overall service ratings for a given service, or for a given locality, or for a given cost range, as well as relative weightages between the factors.

Transaction history is instrumental in deciding the ratings of providers, which are then normalized to Minimum-Maximum values of EDV for each set of corresponding bids. Typically, ranges between a standard configurable scale 1 to 10 or better, 1 to 5 are selected.

At the end of a Quote response deadline, the bids are ranked and arranged—with the best bid at the top, next best below it and so on. Thus it is very useful when the requirement is urgent and needs a quick, objective evaluation of bids from a number of reliable, available and willing providers preferably in close proximity of the requestor.

According to another aspect of the present invention, the logic of application of the weighted parameters is decided on the tenure of the requisition. For short-term jobs, the task specifications are standard and described on the GSPP and readily available with providers. For long-term jobs, initial short-listing of providers can be done through sorting and checking of feedback, estimates etc and the final selection be done automatically for common job specifications with the help of the Computerized bid evaluation (CBE) tool which ranks the bids or in the alternative, manually, if the specifications of each bid/offer are different.

Another aspect of the present invention is the scheduler program function with the inbuilt auto-quote responder function. This serves as an automatic inventory check for products and hence, decides ability of delivery of the provider without waiting for confirmation in person from the said provider. Accordingly, the provider server has an account with a display dashboard, a scheduler (for standard/quick, non-urgent jobs) and other important tools for every registered user, which, upon regular updating by the user, is useful in providing qualified leads to the right providers and for the winning bidder to auto-fill the scheduler. An incoming request can check for Provider availability by matching the calendar window (including the date and time and full time span for the specific job). The Provider may bar requests/Alerts with full overlaps or even with partial overlaps (preventing waste of time through processing ‘undesirable’ leads). Another aspect of the present invention is that a Provider is able to bid for multiple jobs within the same scheduler window even if he won't be able to take on all those jobs. As soon as he wins one job from those, that job will be scheduled in the given window automatically (with the other bids removed from the window automatically). This information can be used with the user interface software (MANSI) to send reminders when various deadlines approach. For providers, any request with certain flexibility (say Delivery Time is given as MCT—Mutually Convenient Time) the quotes can be automatically given if they have provided the product pricing/rates, stock information, normal lead times and a safety margin in their accounts.

The anonymity of bidders is of paramount importance when eliminating the influence of other identity parameters on the success of realizing a transaction.

The present invention adds to this concept by qualifying the anonymity of the bidders with transaction histories by providing a pseudo identity.

Pseudo identities of requestors and providers are thus desirable and achieved with a floating ID given to each member for every Request. This ID is linked to the job id, which is a unique id given for every job (request); and it gives anonymity or a pseudo ID until the winning bidder is determined. All other identity data is not visible to the transacting parties until selection of the best bid.

For effective tracking of tasks, the present invention includes a software tool for generation of pseudo IDs of the supplier that appears in the bid results linked to the job IDs. Every job will have an ID that is derived at the time of the binding request. An example of nomenclature system is the date and time stamp+postcode (zip code)+category/sub category code+serial number from the post-code/category. Further, as this job ID is too long and unwieldy, a truncated ID for the job is used involving only the essential ‘parts’ of the original ID for the individual members to find the particular job details. The non-essential parts of the real job id are hidden and can be constructed through other details if necessary. Thus, all bidders for this job (ID) have their ID's simply as serial numbers 1, 2, 3, . . . n (n being the number of bidders), thus eliminating chances of their identification and such influencing their selection for the transaction. In accordance with the preferred embodiment of the present invention, job IDs for the providers as seen on the their online Account show only the date and the day's serial numbers and not the real job id (a reasonably short id of 3 to 5 digits—in a monthly account, the first two digits being the current date), a necessity for increasing user ergonomics.

Another aspect of the present invention is the use of a customized GUI for displaying job alerts to users. The Multiple Alerts, Notification & Status Indicator (MANSI) tool comprises essentially a system of pop-up windows on an Internet enabled personal computer, which is also connected with a loud speaker. Job alerts may be issued first by activation of an alerting pop-up window for the provider's office computer along with a modulating sound (like a telephone ring tone or other suitable sound)—whenever there is a qualified lead/request coming in. In accordance with the preferred embodiment of the present invention, the MANSI GUI has following characteristics:
a) Multiple Bands on same window—for each category of Notifications (each band giving the total number of Notifications in it)
b) Each band also giving the next deadline (absolute time) for that category.
c) A countdown timer starting when the next deadline approaches (time gap is settable).
d) Fade away or stay ON option (for the PUW)—actionable any time from the Icon in the Task-bar
e) Sound ON/OFF/Volume control for the sound output.
f) Reminders for deadlines and general reminders (there will be a number of such events for each Job Request).
g) Quick-link to the Dashboard for more details (with Icon Active indication in task-bar)
   are connected, as depicted by arrow segments 720 and 721, to a communication network 703. A requestor in the population 701 can communicate with the communication network 703 either by means of a person computer (PC), a telephone, or any other computing and/or communication device (not shown). A population 702 of goods and service providers is connected, as depicted by arrow segments 722 and 721, to the communication network 703. A GSPP portal 707 (also referred to as the GSPP portal or simply as the portal) is connected, as depicted by arrow segments 724 and 723 to the communication network 703. A call centre 708 is connected, as depicted by arrow segments 725 and 723 to the communication network 703. The GSPP portal 707 is connected, as depicted by an arrow 726, to one or more databases 709.

The communication network 703 includes, but is not limited, to the Public Switched Telephone network (PSTN) 704, the Integrated Services Digital Network (ISDN) 705, the Internet 706, and mobile networks such as the GSM network 710. The aforementioned networks are interconnected in such a way as to provide, via the communication network 703, communication between the requestor population 701 and the GSPP portal 707, and between the provider population 702 and the GSPP portal 707.

The requestor population 701 may communicate directly via the communication network 703 to the GSPP portal 707, and/or members of the population 701 may communicate with the GSPP portal 707 via the call centre 708. Similarly, the provider population, or members thereof, may communicate directly with the GSPP portal 707 via the communication network 703. Alternately, members of the provider population 702 may make use of the call centre 708 in order to communicate with the GSPP portal 707.

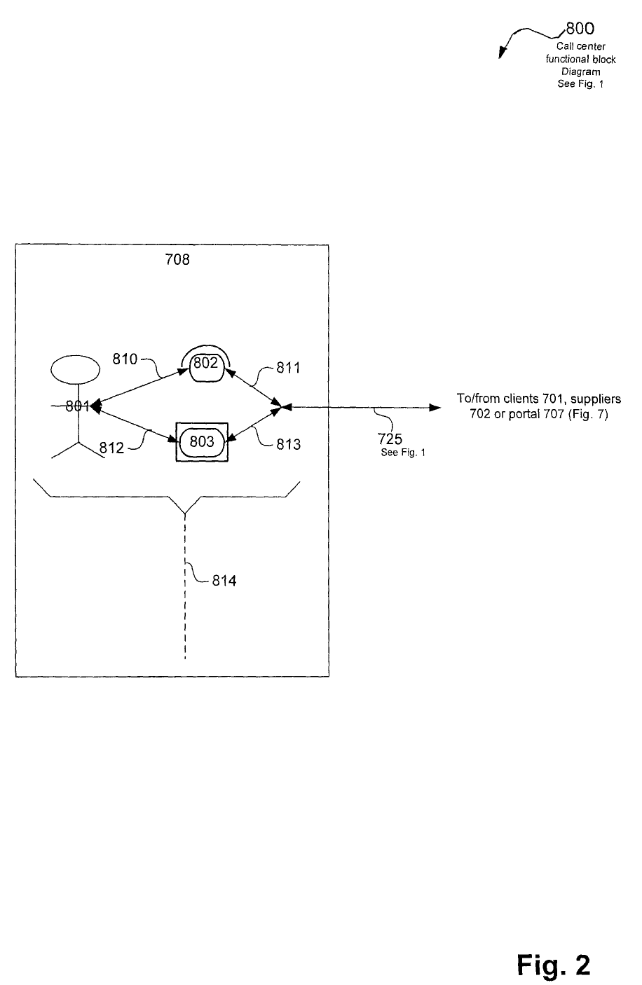

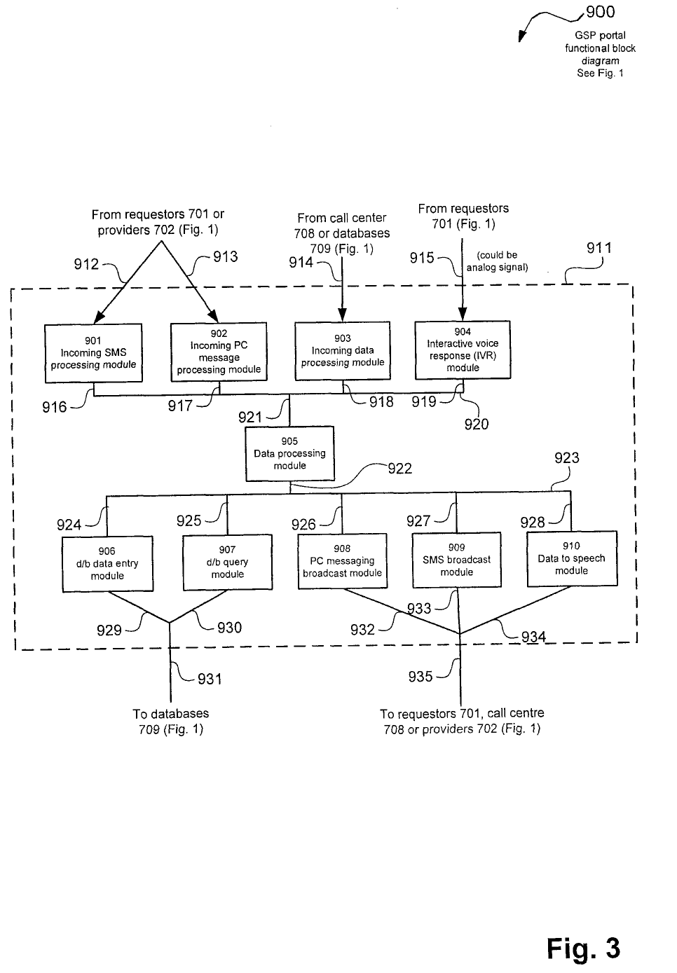

The call centre 708 and the GSPP portal 707 are depicted in hold in order to indicate that further detail is provided, and this detail is shown in FIGS. 2 and 3 respectively.

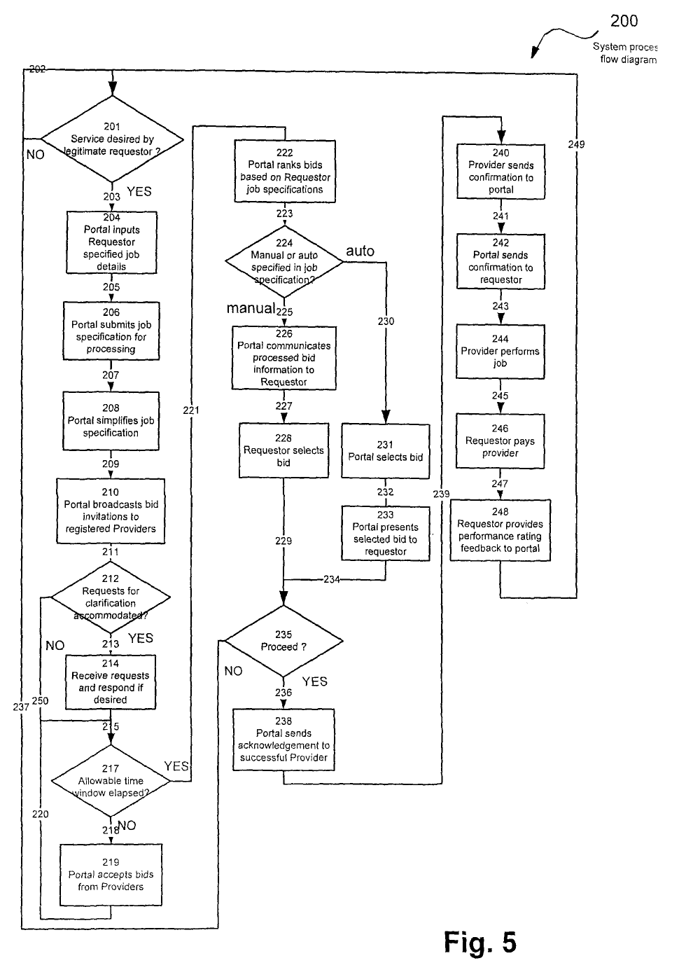

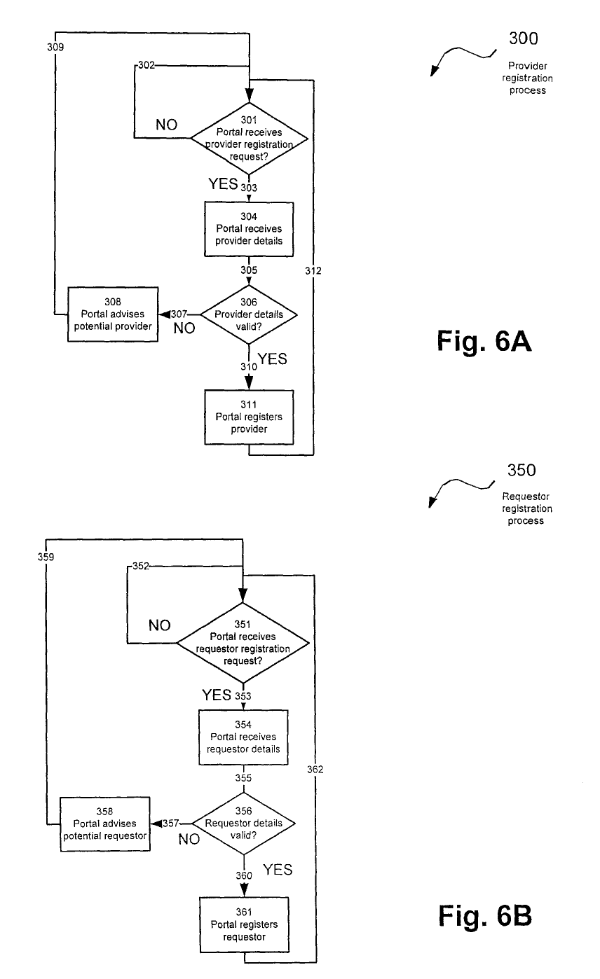

The databases 709, structured either as a single database or as a number of distinct databases, typically store information about goods and services, registered providers, and registered requestors. Registered requestors can, for a fee or as part of their registration privileges, browse the databases 709 in order to identify desired services and/or desired providers. This is an additional feature of the GSPP arrangement and does not feature explicitly in the processes described in relation to FIGS. 5, 6A and 6B.

From a business model perspective, the GSPP portal service can be provided, for a fee to registered requestors and registered providers. Additional per-transaction charges can be levied if desired, a typical transaction being described in relation to FIG. 5.

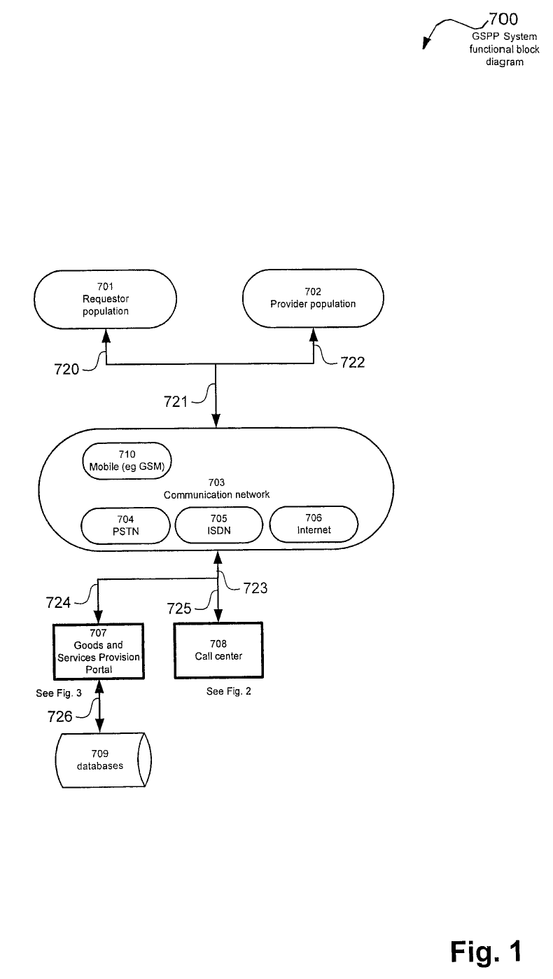

FIG. 2 depicts functional elements in the call centre of FIG. 1. A call centre operator 801 has functional access, as depicted by an arrow 810, to a telephone 802. Similarly, the call centre operator 801 has functional access, as depicted by an arrow 812, to a computer 803. The telephone device 802 and the computer 803 are functionally interconnected, as depicted by arrows 811, 813 and 725, and via the arrow segment 723 in FIG. 1, to the communication network 703.

In functional terms, this means that a requestor in the population 701 in FIG. 3 can, via his or her telephone or other personal communication device (not shown) communicate over the communication network 703 with the call centre operator 801 via the telephone 802. The call centre operator 801 is able to process this incoming communication and construct an appropriate outgoing communication that is sent via the call centre operators PC 803, over the communication network 703 to the GSPP portal 707.

A dashed line 814 depicts the fact that the call centre 708 contains typically a number of call centre operators together with associated telephone, PC and other appropriate devices and facilities. The call centre 708 is thus able to support a level of communications traffic that the GSPP system shown in FIG. 1 is intended to support.

FIG. 3 shows an arrangement of functional modules that form part of the GSPP portal in FIG. 1. Incoming communications from requestor in the population 701 and/or providers in the population 702 (see FIG. 1) can be in the form of short message service (SMS) messages, sent via the cellular phones used by the requestors and/or providers, for example. Alternately, these incoming communications can take the form of PC based messages generated by PCs used by the requestors and/or providers.

Incoming SMS communications as noted above are received, as depicted by an arrow 912, and are pre-processed by an incoming SMS processing mode 901. This module 901 pre-processes incoming SMS messages in order to ensure that the information contained is put into a suitable format for subsequent processing by a data processing module 905. In a similar fashion, incoming PC message information is received, as depicted by an arrow 913, and pre-processed in order to ensure that the incoming information is put into an appropriate format for processing by the data processing module 905.

As described in relation to FIG. 2 incoming voice traffic can be received by the call centre operator 801 who transforms this incoming information into outgoing information via the PC 803. This data traffic is received, as depicted by an arrow 914, and pre-processed by an incoming data processing module 903.

The described arrangement FIG. 3 shows an interactive voice response (IVR) module 904 which can accept, as depicted by an arrow 915, incoming (analogue or digital) voice traffic from requestors in the population 701 and/or providers in the population 702. The extent to which voice traffic is processed either by the call centre 708 or/and the IVR module 904 depends upon cost and performance parameters of both these options.

As noted, the incoming processing modules 901-904 perform pre-processing on incoming communications in order to ensure that these incoming communications are placed in a format that is most effectively used by the data processing module 905. The modules 901-904 are connected, as depicted by respective connections 916, 917, 918 and 919 to a bus 920 and subsequently, via a connection 921 to the data processing module 905. Although a bus a connection structure has been shown, clearly other types of communication between the various modules referred to can be used.

The data processing module 905 processes the incoming information referred to above, and communicates, via a connection 922, a common bus 923, and respective connections 924, 925, 926, 927 and 928 with respective functional modules 906-910.

The module 906 is a database data entry module that is used to enter data into the databases 709 (see FIG. 1) as depicted by connections 929 and 931. The module 907 is a database query module that is used to send queries to and receive responses from the databases 709 as depicted by connections 930 and 931. The module 908 is a PC messaging broadcast module that is used to broadcast messages to a population of PCs as depicted by connections 932 and 935. The module 909 is used to broadcast SMS messages to a population of SMS receives, typically being cellular phones, as depicted by connections 933 and 935. The PC messaging broadcast module 908 sends the aforementioned messages to a population of PCs. The module 910 is a data-to-speech module that constructs speech messages that are directed via connections 934 and 935.

Accordingly, the database data entry module 906 and the database query module 907 communicate with the databases 709 depicted in FIG. 1. The PC messaging broadcast module 908, the SMS broadcast module 909, and the data to speech module 910 communicate with requestors in the population 701, call centre operators in the cell centre 708, and providers in the provider population 702, as depicted in FIG. 1.

The incoming connections 912, 913, 914 and 915 as well the outgoing connection 935 and the bidirectional connection 931 are all carried on the connection 724 in FIG. 1. The connection 931 is carried on the connection 726 in FIG. 1.

The present specification does not go into detail about how various communication functions between the described modules are performed, as these are performed in a manner known in the telecommunications and computer communication arts.

Accordingly, invitations are broadcast, substantially simultaneously as is typical of electronic computer based systems, via the PC messaging module 908, the SMS broadcast module 909, and the data-to-speech module 910 to suitable providers in the population of providers 702. The broadcast is to “suitable” providers because if the requestor is looking for a plumber, clearly the invitations would be broad cast only to the plumbers in the population 702.

Responses from interested providers can be received in a number of ways. Bids from providers using SMS messaging are received by the SMS processing module 901. Bids from providers using PC messaging are received by the PC processing module 902. Bids from providers communicating by voice to the call centre 708 are converted by the call centre operator 801 to data using the PC 803, and this data is received using the incoming data processing module 903. Bids from providers communicating by voice to the GSPP portal 707 are received using the IVR module 904.

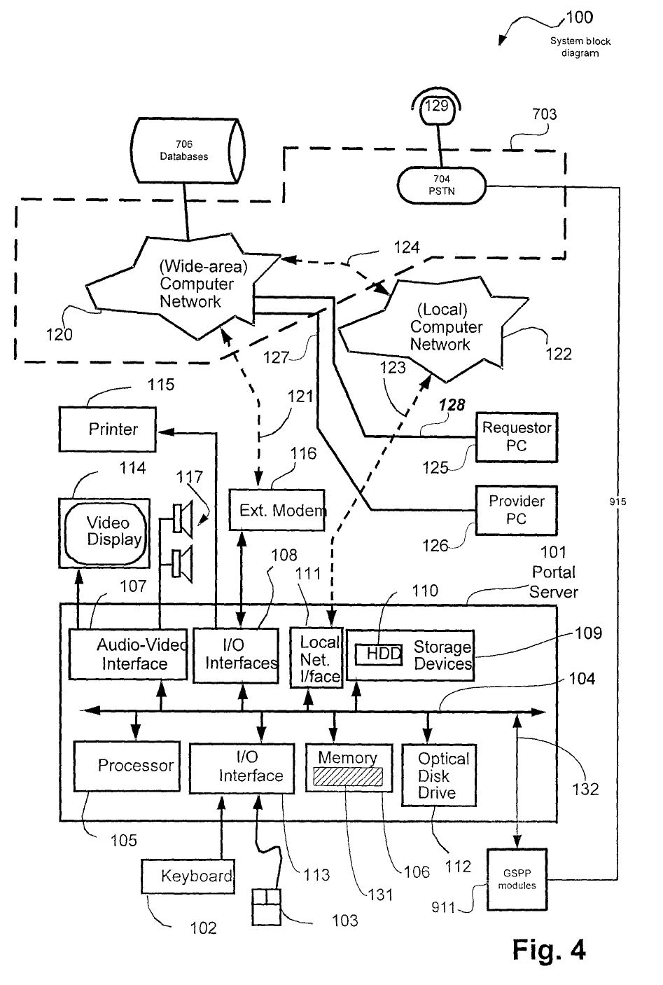

FIG. 4 is a functional block diagram of a general-purpose computer system upon which GSPP arrangements described can be practiced. The GSPP methods may be implemented using a computer system 100, such as that shown in FIG. 4 wherein the processes of FIGS. 5, 6A and 6B may be implemented as software 131, such as one or more application programs executable within the computer system 100. In particular, the steps of the GSPP methods are effected by instructions in the software 131 that are carried out within the computer system 100. The instructions may be formed as one or more code modules, each for performing one or more particular tasks.

The software may also be divided into two separate parts, in which a first part and the corresponding code modules performs the GSPP methods and a second part and the corresponding code modules manage a user interface between the first part and the user. The software may be stored in a computer readable medium, including the storage devices described below, for example. The software is loaded into the computer system 100 from the computer readable medium, and then executed by the computer system 100. A computer readable medium having such software or computer program recorded on it is a computer program product. The use of the computer program product in the computer system 100 preferably effects an advantageous apparatus for practicing the GSPP arrangements.

As seen in FIG. 4, the computer system 100 is formed by a computer module 101 (actually the GSPP portal server), input devices such as a keyboard 102 and a mouse pointer device 103, and output devices including a printer 115, a display device 114 and loudspeakers 117. An external Modulator-Demodulator (Modem) transceiver device 116 may be used by the computer module 101 for communicating to and from a communications network 120 via a connection 121. The network 120 may be a wide-area network (WAN), such as the Internet or a private WAN. Where the connection 121 is a telephone line, the modem 116 may be a traditional “dial-up” modem. Alternatively, where the connection 121 is a high capacity (eg: cable) connection, the modem 116 may be a broadband modem. A wireless modem may also be used for wireless connection to the network 120.

The computer module 101 typically includes at least one processor unit 105, and a memory unit 106 for example formed from semiconductor random access memory (RAM) and read only memory (ROM). The module 101 also includes a number of input/output (I/O) interfaces including an audio-video interface 107 that couples to the video display 114 and loudspeakers 117, an I/O interface 113 for the keyboard 102 and mouse 103 and optionally a joystick (not illustrated), and an interface 108 for the external modem 116 and printer 115.

In some implementations, the modem 116 may be incorporated within the computer module 101, for example within the interface 108. The computer module 101 also has a local network interface 111 that, via a connection 123, permits coupling of the computer system 100 to a local computer network 122, known as a Local Area Network (LAN). As also illustrated, the local network 122 may also couple to the wide network 120 via a connection 124, which would typically include a so-called “firewall” device or similar functionality. The interface 111 may be formed by an Ethernet™ circuit card, a wireless Bluetooth™ or an IEEE 802.21 wireless arrangement.

The interfaces 108 and 113 may afford both serial and parallel connectivity, the former typically being implemented according to the Universal Serial Bus (USB) standards and having corresponding USB connectors (not illustrated). Storage devices 109 are provided and typically include a hard disk drive (HDD) 110. Other devices such as a floppy disk drive and a magnetic tape drive (not illustrated) may also be used. An optical disk drive 112 is typically provided to act as a non-volatile source of data. Portable memory devices, such optical disks (eg: CD-ROM, DVD), USB-RAM, and floppy disks for example may then be used as appropriate sources of data to the system 100.

The components 105, to 113 of the computer module 101 typically communicate via an interconnected bus 104 and in a manner that results in a conventional mode of operation of the computer system 100 known to those in the relevant art. Examples of computers on which the described arrangements can be practised include IBM-PC's and compatibles, Sun Sparestations, Apple Mac™ or alike computer systems evolved therefrom.

The GSPP modules 911 described in relation to FIG. 3 are connected, as depicted by an arrow 132, to the bus 104, and from the bus through the local network interface 111 and the connection 123 to the local network 122 and on to the wide area computer network 120 which is part of the communication network 703 depicted by a polygon in FIG. 4 in dashed bold lines. A requestor PC 125 associated with one of the requestors in the population 701 is connected to the wide area network by a connection 128. A provider PC 126 associated with one of the providers in the population 702 is connected to the wide area network by a connection 127. A telephone 129, usable by either a requestor or a provider is depicted as being connected to the PSTN 704, which is connected as depicted by a connection 915 to the IVR module 904 in the GSPP modules block 911.

Typically, the application programs 131 discussed above are resident on the hard disk drive 110 and read and controlled in execution by the processor 105. Intermediate storage of such programs and any data fetched from the networks 120 and 122 may be accomplished using the semiconductor memory 106, possibly in concert with the hard disk drive 110. In some instances, the application programs may be supplied to the user encoded on one or more CD-ROM and read via the corresponding drive 112, or alternatively may be read by the user from the networks 120 or 122. Still further, the software can also be loaded into the computer system 100 from other computer readable media.

Computer readable media refers to any storage or transmission medium that participates in providing instructions and/or data to the computer system 100 for execution and/or processing. Examples of such storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 114. Through manipulation of the keyboard 102 and the mouse 103, a user of the computer system 100 and the application may manipulate the interface to provide controlling commands and/or input to the applications associated with the GUI(s).

The GSPP arrangement may alternatively be implemented in dedicated hardware such as one or more integrated circuits performing the functions or sub functions of the GSPP approach. Such dedicated hardware may include graphic processors, digital signal processors, or one or more microprocessors and associated memories.

FIG. 5 is a flowchart showing a process of how the GSPP arrangement operates in one example (also referred to as a transaction). The process 200 commences with a step 201 in which the GSPP portal 707 determines if a request for relevant goods and/or services has been received from a legitimate requestor in the population 701. A request is considered to be legitimate if the incoming call is from a requestor who has previously registered with the GSPP service provider as described in more detail at 350 in FIG. 6B. As previously described, a requestor in the population 701 can use their telephone or other portable computing device 129 or their PC 125 in order to communicate their request via the communication network 703 to the GSPP portal 207.

If the step 201 returns a logical FALSE value, then the process 200 follows a NO arrow back to the step 201 in a looping fashion. If on the other hand the step 201 returns a logical TRUE value then the process 200 follows a YES arrow from the step 201 to a step 204. In the step 204 the portal 707 inputs job details specified by the requestor, and in the following step 206 the portal submits the job details for processing. In a subsequent step 208 the portal 707 may simplify the job specification. This simplification step can be performed, for example, to ensure that an outgoing broadcast of invitations to the provider population contains only that information that the provider population requires in order to make bids for the requested service. Thus, for example, the identity of the requestor need not be provided to the provider population in the first instance.

In a following step 210 the portal 707 broadcasts, via one or more of the PC messaging broadcast module 908, the SMS broadcast module 909, and the data to speech module 910, bid invitations to registered providers in the provider population 702.

Turning to the aspect of registered providers, providers need to register, as depicted by a process 300 in FIG. 6A, in order to participate in the GSPP arrangement. Furthermore, in the step 210 the portal 707 performs a filtering process in order to broadcast invitations only to those registered providers who provide relevant services related to the particular request in question.

In a following step 212 the portal 707 determines if the initial request received by the step 201 accommodates requests for clarification by potential providers. If this is the case, then the process 200 follows a YES arrow to a step 214. In the step 214, the portal 707 receives requests for clarification from relevant providers, and passes these requests back to the requestor for her consideration. The requestor in question can then provide the clarification and the portal can send this clarifying information back to the providers who requested clarification. The process 200 then follows an arrow 215 from the step 214 to a step 217.

Returning to the step 212, if the portal 707 determines that a request for clarification was not accommodated in the incoming request for service from the requestor, then the process 200 follows a NO arrow from the step 212 to the step 217.

In the step 217, the portal 707 determines if an allowable time window has elapsed. The time window can be provided explicitly by the requestor in their request for service. Alternately the GSPP arrangement can provide a default window. Clearly, any request for service or goods has a relevant desired response time, and this function accommodates this requirement. If the step 217 determines that the allowable time window has not yet elapsed, then the process 200 follows a NO arrow to a step 219 in which the GSPP portal 707 continues to accept bids from providers. The process then follows an arrow 220 from the step 219 back to the step 217.

If on the other hand, the step 217 determines that the allowable time window has elapsed, then the process 200 follows a YES arrow to a step 222. In the step 222 the portal 707 ranks bids for the service or goods required based upon the requestor job specifications. This ranking process is further described in relation to the examples in the APPENDICES. The process 200 then follows an arrow 223 to a step 224 in which the portal 707 determines if the incoming request at the step 201 specified “manual” or “automatic” operation in the job specification.

A requestor can specify automatic operation if the requestor wishes the GSPP arrangement to automatically select a provider for the job. Alternately, the requestor can specify manual operation if the requestor wishes to make a final selection of provider herself. If the step 224 determines that manual operation has been specified, then the process 200 follows a “manual” arrow from the step 224 to a step 226. In the step 226, the portal 707 communicates the processed bid information to the requestor, after which in a step 228 the requestor selects the bid based upon their own analysis of the processed bid information received. The process 200 then follows an arrow 229 to a step 235. In the step 235, the GSPP portal 707 asks the requestor if they wish to proceed with the entire transaction.

If in the step 235 the requestor indicates that they do not wish to proceed with the present transaction, then the process 200 follows a NO arrow from the step 235 back to the step 201. This election by the requestor can be used for a number of different purposes. In the first instance, it may be that the requestor simply wishes to terminate the transaction and has changed their mind about requesting the goods or services based upon the response from the various providers. In this case, the transaction clearly terminates and the process 200 waits in the step 201 for the next request from a requestor in the population 701 for goods or services. Alternately, it may be that the requestor in question wishes to refine their request based upon information received from the providers who have given bids. The GSPP arrangement enables a requestor to recall previous requests, and to modify and then resubmit these requests. This option can be used by requestors to merely modify their requests based upon information received by potential providers, or enables them to choose between various bids provided by the potential providers.

Although not explicitly described in FIG. 5, a request for goods and/or services from a requestor can include a request for various types of quotes in the same bid. Thus, for example, a job specification from a requestor for repair of a PC may request bids for carrying out the repair either at the requestor's residence, or at the provider's place of business. The manual/auto selection option in the step 224 enables the requestor to manually select a desired bid, and to provide this information in the step 235.

Returning to the step 224, if the job specification from the requestor specifies automatic operation, then the process 200 follows an “auto” arrow from the step 224 to a step 231. In the step 231, the GSPP portal 707 selects the optimum bid as will be explained in more detail with reference to the examples in the APPENDICES. In a following step 233, the portal 707 presents a selected bid to the requestor, and the process 200 then follows an arrow 234 to the step 235.

If the step 235 determines that the requestor wishes to continue with the transaction, then the process 200 follows a YES arrow to a step 238. In step 238 the portal 707 sends an acknowledgement message to the successful provider. The process 200 then follows an arrow 239 to a step 240. In the step 240 the successful provider sends a confirmation to the portal 707 after which the portal 707 sends confirmation to the requestor in a step 242.

It is evident that the process described thus far in relation to FIG. 5 involves the following steps:
(a) A requestor submits a job specification;
(b) The portal processes the request and broadcasts invitations to bid to a subset of the registered provider population 702;
(c) Those providers interested in making a bid for the specified job send bids back to the portal 707;
(d) The portal ranks the received bids according to criteria set by the requestor in the job specification. These criteria can include one ore more of urgency, price, proximity, and performance rating based upon stored feedback for the provider from previous transactions;
(e) The ranked bids are either considered by the requestor and a winning bid is selected, or the portal makes an automatic selection and advises the requestor thereof;
(f) The portal sends an acknowledgement to the successful provider;
(g) The provider sends a confirmation back to the portal, thereby indicating that they are still interested in taking the job;
(h) The portal sends confirmation to the requestor. The contact details (including names, addresses, telephone contact information and so on) of the requestor and the provider are sent to the respective opposite parties. The agreed prices, time of arrival, job details and terms of payment can also be included.

Returning to FIG. 5 after the portal in the step 242 sends confirmation to the requestor, the process 200 follows an arrow 243 to a step 244 in which the provider performs the aforementioned job. Thereafter, in a step 246 the requestor pays the provider, and in a following step 248 the requestor provides performance-rating feedback to the portal. The process 200 then follows an arrow 249 back to the step 201.

FIG. 6A shows a flowchart for a process 300 enabling a new provider to register with the GSPP system. The process 300 commences with a step 301 in which the portal 707 waits for a request for registration from a new provider. While such a request is not received, the process 300 follows a NO arrow back to the step 301 in a looping fashion. When the step 301 receives a request, then the process 300 follows a YES arrow to a step 304 in which the portal 707 receives provider details. These details would typically include but would not be limited to the name and address and contact information of the provider, catalogue information for the provider that could be stored in the databases 709 for access by the requestor population 701, and other advertising material.

The process 300 then follows an arrow 305 to a step 306 in which the portal 707 determines if the provider details are valid. This validity check can encompass a variety of considerations. Such considerations can include simple tests such as completeness of data, so that if a potential provider did not provide contact information, the received data will be considered to be not valid. The considerations can also extend to comparing the potential provider details against a database of deregistered providers, and possibly refusing registration in such cases. If the step 306 determines that the provider details are not valid, then the process 300 follows a NO arrow to a step 308. In the step 308 the portal 707 advises the potential provider about the invalid information, and the process 300 follows an arrow 309 back to the step 301. If the data invalidity arose from a simple omission of data, then the potential provider can resubmit a registration request with the correct data.

Returning to the step 306, if the provider details are found to be valid, then the process follows a YES arrow to a step 311 in which the portal 707 registers the provider as a member of the provider population 702. The process 300 then follows an arrow 312 back to the step 301.

FIG. 6B shows a flowchart for a process 350 enabling a new requestor to register with the GSPP system. The process 350 commences with a step 351 in which the portal waits to receive a new registration request. While no such request is received, the process 350 follows a NO arrow back to the step 351 in a looping fashion. When the step 351 receives a new registration request, the process 350 follows a YES arrow to a step 354 in which the portal 707 receives details of the new requestor.

In a following step 356, the portal 707 checks whether the requestor details provided are valid. This validity check can, in a similar fashion to the process 300 in regard to new potential providers, range from simple completeness checks through to checks against a database register of deregistered requestors and so on. If the step 356 indicates that the requestor details are not valid, then the process 350 follows a NO arrow to a step 358 in which the portal 707 advises the potential requestor of the deficiencies found in the provided details. The process 350 then follows an arrow 359 back to the step 351. In the step 351, if the information provided by the potential new requestor can be easily corrected, the requestor can correct it and resubmit a new request.

Returning to the step 356, if the potential requestor details are valid, then the process 350 follows a YES arrow to a step 361. In the step 361, the portal 707 registers the new requestor into the population 701 of registered requestors. The process 350 then follows an arrow 362 back to the step 351.

The disclosed GSPP arrangements enable a requestor to receive a number of quotations (i.e. bids) for whichever goods or services are required. These bids can be requested on an urgent basis, in which case potential providers will provide their bids accordingly (ie with a commitment to provide the service within a specified time window intended to satisfy the requestor's requirement). The GSPP arrangements are suitable for provision of goods and/or services (hereinafter referred to by the term services) of virtually any nature and spanning virtually any market.

Thus, for example, requests for urgent services from potential providers in the immediate area of the requestor may be specified in the service request, or alternately, the geographic location of the providers may be omitted in which case providers from any geographic area may respond with a bid. This latter type of example would be suitable, for example, if the desired goods are computer software packages or furniture. On the other hand, urgent services relating to providers in the immediate area of the requestor relate to services such as urgent plumbing jobs.

The GSPP arrangements support pre-quote inspections through, for example, the step 212 in FIG. 5. The steps 212 and 214 enable, if a requestor so desires, a potential provider to make a pre-quote inspection of the property, such as might be suitable in the case of a request for building services.

In the job specification, requestors can specify a number of parameters, as will be described in relation to the example in the APPENDICES, these parameters forming the basis upon which the portal ranks bids in the step 222 in FIG. 5. Such parameters can include, but are not limited, to (a) price, (b) speed with which the service can be provided, (c) performance rating (this being a function of the performance rating feedback provided in the step 248 in FIG. 5), and (d) the geographic proximity of the potential provider to the requestor.

The GSPP arrangements can accommodate a number of different operating modes, by which the requestor can provide either a fully customised service request in relation to the aforementioned parameters, or alternately, can use a number of default parameters provided by the GSPP system.

In the step 222 in FIG. 5 the GSPP arrangement processes all the received bids from the interested providers, and ranks the bids in order according to the extent to which the bids satisfy the parameters set by the requestor. Thus, for example, depending upon the relative weight given to price and performance rating, the GSPP arrangement may choose a more expensive bid with a higher feedback rating rather than the cheapest bid which in the example considered may be by a provider with a low feedback rating. The aforementioned feedback ratings are essentially indications of customer satisfaction with the service provided in previous transactions, this being stored in the database 709 by the step 248 in FIG. 5.

The step 210 in FIG. 5 results in a mixture of PC messages, SMS messages, and voice messages being broadcast to relevant providers in the population 702.

The APPENDICES show various examples of how the GSPP arrangements can be implemented using spreadsheets.

### EXAMPLE 1

The spreadsheet for Example 1 in APPENDIX A relates to a requestor who is looking for a plumber to fix a blocked drain and two leaky taps. Two views, referred to here as the value view (which is shown first on page 28) and the formula view (which is shown second on pages 29-30) of the spreadsheet are shown in APPENDIX A. The value view shows the computed values in each cell such as the value 110 in the cell C27. The formula view shows the formulae used by the spreadsheet to compute the aforementioned values, such as the formula (E15+(E10−E15)*F20/100×E15*(G10−G15)/G15*(100−F20)/100 in the cell C27. When spreadsheet cells are referred to, unless explicitly stated, the view being referred to is determined by the context of the reference.

The requestor inputs are shown in cells C3:F4 and include the following information:
The requestor is prepared to pay by credit card;
the job is to be done between 9:30 am and 12:00 pm on the day of the request;
The job consists of fixing a blocked drain and two leaky taps.

The aforementioned details are provided in the service request that is received by the portal in the step 204 in FIG. 5.

As depicted at D2:H2 the requestor has, by not electing to provide specific weights for the available input parameters (ie cost, feedback performance rating, urgency and proximity as depicted at D33:H36), effectively elected the “auto-default mode”, which means that the job is open to all bidders and that the lowest bid defines the winning provider.

The bids received from the interested providers in the step 219 of FIG. 5 are shown in cells E10:F14. The bids are two dimensional, comprising a charge for doing the requested job, and a time of arrival. Thus provider No. 1, as indicated at D10, offers as depicted at E10:F10 to do the job for $110 and to arrive at 10:30 am. Provider No. 5, as indicated at D14, offers as depicted at E14:F14 to do the job for $120 and to arrive at 11:15 am.

The GSPP arrangement ranks (see the step 222 in FIG. 5) the various bids received from the providers in question, the resultant ranks being shown at C27:C31. In the present arrangement, the ranks are identical to the prices quoted by the providers, and the lowest rank indicates the winning bid. Accordingly, the bid for provider No. 1 which has a rank value of 110.00 indicates that provider No. 1 is the winner.

### EXAMPLE 2

The spreadsheet for Example 2 in APPENDIX B relates to a requestor who is looking for a dentist to attend to her toothache. Two view, ie the value view (which is shown first on page 32) and the formula view (which is shown second on pages 33-37) of the spreadsheet are shown in APPENDIX B. When spreadsheet cells are referred to, unless explicitly stated, the view being referred to is determined by the context of the reference.

The requester inputs are shown in cells C40:F41 and include the following information
the job is to be done between 9:30 am and 12:00 pm on the day of the request;
The job consists of attending to a tooth ache.

The aforementioned details are provided in the service request that is received by the portal in the step 204 in FIG. 5.

As depicted at D39:H39 weights have been provided for urgency (UF) and proximity (PF). In regard to urgency, the defined weight of 70 indicates medium urgency and contrasts with the default value for urgency of 50 which means no urgency (see C71:I71 for ranges and definitions for urgency weights and meanings). In regard to proximity, the defined weight of 60 indicates a low priority on proximity, however, this contrasts with the default value for proximity of 50 which means no priority on proximity (see C72:I72 for ranges and definitions for proximity weights and meanings).

The bids received from the interested providers in the step 219 of FIG. 5 are shown in cells E46:F50 and H46:I50. The bids are three dimensional in this example, comprising a charge for doing the request job (eg E46), a time of arrival (eg F46), and a proximity (eg I46). In regard to the proximity, although this is referred to loosely as a provider input, this parameter is typically not input when bidding for the job in question, but is rather part of the information given by the provider at the step 304 in FIG. 6A when registering for membership of the GSPP arrangement. Thus provider No. 1, as indicated at D46, offers as depicted at E46:F46 to do the job for $110 and to arrive at 10:30 am. The performance rating for provider No. 1 is retrieved from the database 709 where it had been previously stored as a result of feedback for the provider from other jobs (see the step 248 in FIG. 5) and is depicted as having a value of “5” at G46. A time delay of “60” at H46 reflects the delay between the beginning of the job window ie 09:30 at C41 and the estimated time of arrival promised by the bidder ie 10:30 at F46. The proximity of Provider No. 1 from the requestor is has a value of “7.0” which means that the provider is 7 km away from the requestor. Instead of a new distance, the GSPP arrangement can instead determine the estimated travelling time.

The GSPP arrangement ranks (see the step 222 in FIG. 5) the various bids received from the providers in question, the resultant ranks being shown at F63:F67 in the present example, because this cell range relates to examples in which weights have been provided for urgency and proximity (as depicted at F62). In the present arrangement, the lowest rank indicates the winning bid as in example 1. Accordingly, the bid for provider No. 5 which has a rank value of 62.16 indicates that provider No. 5 is the winner. The formula used in this example to determine the ranks of the providers is shown in the formula view at the cell F67 as (E51+(E49−E51)*F56/100−E51*(G49−G51)/G51*(100−F56)/100)*(F57/100+(F57−(100−F57)/100*H50/H52)*F58/100+(F58−(100−F58)/100*I50/I52).

### EXAMPLE 3

The spreadsheet for example 3 relates to another aspect of the present invention wherein is outlined a statistical system of evaluating the best bid among those placed by providers responding to job requests comprising a plurality of logically weighted attributes. The statistics outlined hereinafter form the core logic of the Computerized Bid Evaluation (CBE) tool. Reference is hereby made to accompanying spreadsheet wherein is illustrated one example of working of the statistical formula for calculation of the Effective Dollar Value (EDV) on basis of four attributes the value of each being specified by the user while generating the job request.

Matrix C5:H13 represents value of parameters proposed by providers in response to the job description broadcasted. The CBE formula functions to rank the bids in order of their suitability to the qualified job descriptions. Matrix A28:G32 indicates scale on which user-specified values of the job parameters are considered for their degree of suitability to the available job request. Referring to matrix F18:J23, it can be seen that each column is indicative of the overall delivery to be expected by the requester and hence, a fair balance has to be achieved for evaluation of the best suitable bid. Accordingly, Column H18:23 can be seen to indicate a fair balance of product quality, time for delivery of the product, cost and quality rating of the bidder. Thus, a truly optimal bid is selected on basis of both tangible properties like product quality, delivery time and cost, but also subjective intangible attributes including ratings of providers on the aforementioned scale of user-specified values. As ratings of providers are decided by feedback obtained from requesters after completion of transactions, this parameter too, is real time updated and hence, plays an important role in selectability of a particular provider in future transactions. It is due to this performance-based nature of the distributed purchase system proposed by the present invention, that requesters can avail of a plurality of providers among an impartial market while the providers have to keep up their performance levels get consistent ratings.

Matrix A14:E17 represents the system of assignment of weightage to job parameters. The default values for the same are as indicated at D15-17. The cells E15-17 indicate the weightage assigned by the requester while making the job request. Depending on the calibration of the response system (threshold or range of parameter values specified by bidder to be considered adequate to suffice requisition by requester), best bid is evaluated. Referring to the spreadsheet, the default weightage for dollar-quality, urgency and proximity factors are 50%, 75% and 75% respectively. However, the user requisition puts these weightages at 65%, 50% and 50% respectively. Therefore, to determine the best bid among those forwarded by providers, EDV of these bids is calculated using the following formula (D13+(D8−D13)*E15/100−D13*(E8−E13)/E13*(100−E15)/100)*(E16/100 +(E16−(100−E16))/100*F8/F14)*(E17/100 +(E17−(100−E17))/100*G8/G14). To get these EDV values into comparable form, these are further linearized by the formula 1+((B22−MIN($B$22:$B$26))/(MAX($B$22:$B$26)−MIN($B$22:$B$26))*9). Thus, after normalization, the best bid would have a score of 1 while the worst bid would have a score of 10. Column C22-26 shows EDV values after normalization. Original EDV values are shown at B22-26.

Although the invention has been described and illustrated in connection with preferred embodiments, many variations and modifications, as will be apparent to those of skill in the art, may be made without departing from the spirit and scope of the invention. The invention as set forth in the appended claims is thus not limited to the precise details of construction set forth above as such variations and modifications are intended to be included within the spirit and scope of the invention as set forth in the claims.

Where reference is made in any one of the accompanying drawings to steps and/or features, which have the same reference numerals, those steps and/or features have for the purposes of this description the same function(s) or operation(s), unless the contrary intention appears.

It is to be noted that the discussions contained in the “Background” section relating to prior art arrangements relate to discussions of devices that may be public knowledge through their use. Such discussions should not be interpreted as a representation by the present inventor(s) or patent applicant that such devices in any way form part of the common general knowledge in the art.

FIG. 1 shows a functional block diagram for a system 700 upon which the goods and services provision (GSPP) arrangement [symbol] . A population 701 of requestors

[symbol]

### INDUSTRIAL APPLICABILITY

It is apparent from the above that the arrangements described are applicable to the computer and data processing industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

APPENDIX A

| | A | B | C | D | E | F | G | H | I | J |
|---|---|---|---|---|---|---|---|---|---|---|
| 1 | | | | | | | | | | |
| 2 | E1 | Example 1 | [symbol] | [symbol] | | | | | | |
| 3 | E1 | [symbol] | [symbol] | [symbol] | | | | | | |
| 4 | E1 | | [symbol] | [symbol] pay by Credit Card | | | | | | |
| 5 | E1 | | | | [symbol] | | | | | |
| 6 | E1 | CBE operation | data given by [symbol] | Server | [symbol] | Provider | [symbol] | [symbol] | [symbol] | [symbol] |
| 7 | E [symbol] | | | [symbol] | [symbol] | [symbol] | [symbol] | [symbol] | [symbol] | [symbol] |
| 8 | E [symbol] | | | | [symbol] | [symbol] | QRating | dT | [symbol] | |
| 9 | E [symbol] | | | | | [symbol] | | (Tₐ − Tₛ) | | |
| 10 | E [symbol] | | | 1 | [symbol] | [symbol] | [symbol] | | | |
| 11 | E [symbol] | | | 2 | [symbol] | [symbol] | [symbol] | | | |
| 12 | E [symbol] | [symbol] | [symbol] | 3 | [symbol] | [symbol] | [symbol] | | | |
| 13 | E [symbol] | [symbol] | Payment Method [symbol] Cash [symbol] | 4 | [symbol] | [symbol] | [symbol] | | | |
| | | | Credit Card [symbol] | | | [symbol] | [symbol] | | | |
| 14 | E [symbol] | [symbol] | [symbol] | 5 | [symbol] | [symbol] | [symbol] | | | |
| 15 | E [symbol] | | Co [symbol] the Server for CBE [symbol] | Avg [symbol] | [symbol] | | [symbol] | | | |
| 16 | E [symbol] | | | | | | | | | |
| 17 | E [symbol] | | | | | | | | | |
| 18 | E [symbol] | [symbol] Cells [symbol] 20 22, 22 respectivly [symbol] Pre-Standard [symbol] | | | | | | | | |
| 19 | E [symbol] | [symbol] | | | Min (N) | Low (L) | Med (M) | High (H) | Max (X) | Def (D) |
| 20 | E [symbol] | [symbol] | 100% [symbol] | E1 | [symbol] | [symbol] | | | | |
| 21 | E [symbol] | [symbol] | [symbol] | [symbol] | [symbol] | [symbol] | | | | |
| 22 | E [symbol] | [symbol] | [symbol] | [symbol] | [symbol] | [symbol] | | | | |
| 23 | E [symbol] | | | | [symbol] | [symbol] | [symbol] | | | |
| 24 | E [symbol] | | | | | | | | | |
| 25 | E [symbol] | CBE Scores for Comparison - | | (Consider this an | | | Computed by | | | |
| | | (Smallest value is winner) | | Effective Dollar Value) | | | Server | | | |
| 26 | E [symbol] | [symbol] | EDV with C & R only | [symbol] | [symbol] | [symbol] | [symbol] | | | |
| 27 | E [symbol] | 1 | [symbol] | | | | [symbol] | | | |
| 28 | E [symbol] | 2 | [symbol] | | | | [symbol] | | | |
| 29 | E [symbol] | 3 | [symbol] | | | | [symbol] | | | |
| [symbol] | E [symbol] | 4 | [symbol] | | | | [symbol] | | | |
| [symbol] | E [symbol] | 5 | [symbol] | | | | [symbol] | | | |
| [symbol] | E [symbol] | For Pre- [symbol] & [symbol] | The [symbol] of [symbol] . The default value | Min (N) | Low (L) | Med (M) | High (H) | Max (X) | Default (D) | |
| | | [symbol] only | will be somewhere in | | | | | | | |
| | | | between [symbol] to be [symbol] ) | | | | | | | |
| [symbol] | E [symbol] | | Cost | 100 | [symbol] | [symbol] | [symbol] | [symbol] | [symbol] | |
| [symbol] | E [symbol] | | Rating | [symbol] | [symbol] | [symbol] | [symbol] | 100 | [symbol] | |
| [symbol] | E [symbol] | | Urgency | [symbol] | [symbol] | 10 | [symbol] | 100 | [symbol] | |
| [symbol] | | | Proximity | [symbol] | [symbol] | [symbol] | [symbol] | 100 | [symbol] | |
| [symbol] | | | | | | | | | | |

| | A | B | C | D |
|---|---|---|---|---|
| 1 | | | | |
| 2 | E1 | Example 1 | Day job - No Urgency - On-site | |
| 3 | E1 | Call a plumber | [symbol] | Job Descrition: Blocked Drain: [symbol] |
| 4 | E1 | | Job window - [symbol] - [symbol] | Will pay by Credit Card |
| 5 | E1 | | | |
| 6 | E1 | CBE operation | Data given by [symbol] | Server |
| 7 | E1 | | | [symbol] |
| 8 | E1 | | | |
| 9 | E1 | | | |
| 10 | E1 | | | 1 |
| 11 | E1 | | | 2 |
| 12 | E1 | [symbol] | [symbol] Minimum [symbol] | 3 |
| 13 | E1 | [symbol] | [symbol] | 4 |
| 14 | E1 | [symbol] | [symbol] | 5 |
| 15 | E1 | | Computed By the Server for CBE purpose [symbol] | Avg -->>> |
| 16 | E1 | | | |
| 17 | E1 | | | |
| 18 | E1 | [symbol] | | |
| 19 | E1 | [symbol] | | |
| 20 | E1 | [symbol] | 100% [symbol] on [symbol] | R [symbol] |
| 21 | E1 | [symbol] | No Urgency [symbol] in the given [symbol] | R [symbol] |
| 22 | E1 | [symbol] | | R [symbol] |
| 23 | E1 | | No [symbol] | |
| 24 | E1 | | | |
| 25 | E1 | CBE Scores for com [symbol] | | (Consider this an Effective [symbol] |
| 26 | E1 | [symbol] Sr [symbol] | EDV with C & R only | [symbol] |
| 27 | E1 | 1 | [symbol] | |
| 28 | E1 | 2 | [symbol] | |
| 29 | E1 | 3 | [symbol] | |
| 30 | E1 | 4 | [symbol] | |
| 31 | E1 | 5 | [symbol] | |
| 32 | E1 | [symbol] | [symbol] | Min (N) |
| 33 | E1 | | Cost | [symbol] |
| 34 | E1 | | Rating | [symbol] |
| 35 | E1 | | Urgency | [symbol] |
| 36 | E1 | | Proximity | [symbol] |
| 37 | | | | |
| 38 | | | | |

| | E | F | G | H | I | J |
|---|---|---|---|---|---|---|
| 1 | | | | | | |
| 2 | | | | | | |
| 3 | | | | | | |
| 4 | | | | | | |
| 5 | G2 [symbol] | | | | | |
| 6 | [symbol] | [symbol] | [symbol] | [symbol] | [symbol] | [symbol] |
| 7 | [symbol] | [symbol] ETA | [symbol] | [symbol] | [symbol] | [symbol] |
| 8 | [symbol] | [symbol] | QRating | dT | [symbol] | |
| 9 | | [symbol] | | (Tₐ − Tₛ) | | |
| 10 | [symbol] | 1000 | [symbol] | | | |
| 11 | [symbol] | 1000 | [symbol] | | | |
| 12 | [symbol] | 1045 | [symbol] | | | |
| 13 | [symbol] | 11 [symbol] | [symbol] | | | |
| 14 | [symbol] | | [symbol] | | | |
| 15 | AVERAGE [symbol] | | AVERAGE [symbol] | | | |
| 16 | | | | | | |
| 17 | | | | | | |
| 18 | | | | | | |
| 19 | Min (N) | Low (L) | Med (M) | High (H) | Max (X) | Def (D) |
| 20 | | [symbol] | | | | |
| 21 | | [symbol] | | | | |
| 22 | | [symbol] | | | | |
| 23 | [symbol] | [symbol] | [symbol] | | | |
| 24 | | | | | | |
| 25 | | | Computed by Server | | | |
| 26 | [symbol] | [symbol] | [symbol] | | | |
| 27 | | | v | | | |
| 28 | | | w | | | |
| 29 | | | x | | | |
| 30 | | | y | | | |
| 31 | | | z | | | |
| 32 | Low ( [symbol] ) | Med (M) | High (H) | Max (X) | Default (D) | |
| 33 | [symbol] | [symbol] | [symbol] | [symbol] | [symbol] | |
| 34 | 20 | 40 | 70 | [symbol] | [symbol] | |
| 35 | [symbol] | [symbol] | 85 | [symbol] | [symbol] | |
| 36 | [symbol] | [symbol] | [symbol] | [symbol] | [symbol] | |
| 37 | | | | | | |
| 38 | | | | | | |

[symbol]

[symbol]

indicates data missing or illegible when filed

APPENDIX B

| | A | B | C | D | E | F | G | H | I | J |
|---|---|---|---|---|---|---|---|---|---|---|
| 39 | E2 | Example 2 | Day job - Urgent - | Urgency [symbol] | | | | | | |
| | | | Off-site | | | | | | | |
| 40 | E2 | D [symbol] | ( [symbol] Request at | Job Description: Tooth Ache | | | | | | |
| | | | 0000 hrs) | | | | | | | |
| 41 | E2 | | Job window - | [symbol] E #Pr [symbol] | | | | | | |
| | | | 0000-1200 | (CR [symbol] D UF [symbol] M, [symbol] ) | | | | | | |
| 42 | E2 | CBE | data given by >>> | Server | [symbol] | [symbol] | [symbol] | [symbol] | [symbol] | |
| | | operation | | | | | | | | |
| 43 | E2 | | | Sr [symbol] | [symbol] | TOA/ETA | [symbol] | [symbol] | [symbol] | |
| 44 | E2 | | | | [symbol] | Hrs | CRa [symbol] g | [symbol] T | [symbol] | |
| 45 | E2 | | | | | T4 | | ( [symbol] ) | | |
| 46 | E2 | | | 1 | 110 | 1000 | [symbol] | [symbol] | [symbol] | |
| 47 | E2 | | | 2 | [symbol] | 1000 | [symbol] | [symbol] | [symbol] | |
| 48 | E2 | Preferences | Bidder Rating | 3 | [symbol] | 1145 | [symbol] | [symbol] | [symbol] | |
| | | | (No Min [symbol] ) [symbol] | | | | | | | |
| 49 | E2 | [symbol] | Payment Method | 4 | [symbol] | 1100 | [symbol] | [symbol] | [symbol] | |
| | | | ( [symbol] Credit Card) | | | | | | | |
| 50 | E2 | [symbol] | [symbol] Offsite ( [symbol] ) | 5 | [symbol] | 11 [symbol] | [symbol] | [symbol] | [symbol] | |
| 51 | E2 | | Computed by the | Avg ->>> | 121 | | [symbol] | 40 | [symbol] | Radius (Mi [symbol] |
| | | | Server for CBE | | | | | | | |
| | | | purposes [symbol] | | | | | | | |
| 52 | E2 | | | | | | Window | [symbol] | [symbol] | [symbol] |
| 53 | E2 | | | | | | | | | |
| 54 | E2 | R1, R2, R3 (data in [symbol] E56 | | | | | | | | |
| | | 57 58 [symbol] of the Pre-Standard [symbol] | | | | | | | | |
| 55 | E2 | | | Min (N) | Low (L) | Med (M) | High (H) | Max (X) | Def (D) | |
| 56 | E2 | [symbol] | [symbol] | R1 | | [symbol] | [symbol] | D ( [symbol] ) | | |
| 57 | E2 | [symbol] | [symbol] - URG (Medium) | R2 | | [symbol] | [symbol] | D - [symbol] | | |
| 58 | E2 | [symbol] | [symbol] (Job on site) - | R3 | | [symbol] | [symbol] | D to L ( [symbol] ) | | |
| | | | Low | | | | | | | |
| 59 | E2 | | | | [symbol] | [symbol] | [symbol] | | | |
| 60 | E2 | | | | | | | | | |
| 61 | E2 | CBE Scores for Comparison - | | Consider this an | | | Computed by | | | |
| | | (Smallest value is winner) | | Effective Dollar Value) | | | Server | | | |
| 62 | E2 | [symbol] | EDV with | [symbol] | [symbol] | UF & PF (Urgent) | [symbol] | | | |
| | | | C & R only | | | & [symbol] | | | | |
| 63 | E2 | 1 | 117. [symbol] | [symbol] | 87.29 | [symbol] | v | | | |
| 64 | E2 | 2 | 124.6 [symbol] | 10 [symbol] .12 | 97.25 | [symbol] | w | | | |
| 65 | E2 | 3 | 116.42 | 93.14 | [symbol] | [symbol] | x | | | |
| 66 | E2 | 4 | 11 [symbol] | [symbol] | [symbol] | [symbol] | y | | | |
| 67 | E2 | 5 | 127. [symbol] | [symbol] .41 | [symbol] | [symbol] | z | | | |
| 68 | | For Pre - [symbol] & Pre - | The [symbol] of [symbol] The default | Min | Low | Med | High | Max | Default | |
| | | [symbol] only | value will be | (N) | (L) | (M) | (H) | (X) | (D) | |
| | | | somewhere in | | | | | | | |
| | | | between ( [symbol] to be [symbol] ) | | | | | | | |
| 69 | | | Cost | 100 | [symbol] | [symbol] | [symbol] | 0 | [symbol] | |
| 70 | | | Rating | 0 | [symbol] | 40 | 70 | 100 | [symbol] | |
| 71 | | | Urgency | [symbol] | [symbol] | [symbol] | [symbol] | 100 | [symbol] | |
| 72 | | | Proximity | [symbol] | [symbol] | 7 [symbol] | [symbol] | 100 | [symbol] | |
| 73 | | | | | | | | | | |
| 74 | | | | | | | | | | |

| | A | B | C |
|---|---|---|---|
| 39 | E2 | Example 2 | Day job - Urgent - Offsite |
| 40 | E2 | Dentist | ( [symbol] -Request at [symbol] ) |
| 41 | E2 | | Job window [symbol] - 1200 |
| 42 | E2 | CBE operation | data given by ->>> |
| 43 | E2 | | |
| 44 | E2 | | |
| 45 | E2 | | |
| 46 | E2 | | |
| 47 | E2 | | |
| 48 | E2 | [symbol] | Bidder rating No Min [symbol] CR Weight [symbol] |
| 49 | E2 | [symbol] | Payment Method ( [symbol] Credit Card) |
| 50 | E2 | [symbol] | [symbol] |
| 51 | E2 | | Computed by the Server for CBE purposes ->>> |
| 52 | E2 | | |
| 53 | E2 | | |
| 54 | E2 | R2, R3, [symbol] | |
| 55 | E2 | | |
| 56 | E2 | CR Balance | CR - ( [symbol] ) De [symbol] |
| 57 | E2 | [symbol] (E- [symbol] ) | Urgency Consideration - URG (Medium) |
| 58 | E2 | [symbol] (N- [symbol] ) | Pr [symbol] Consideration ( [symbol] on site) - L (Low) |
| 59 | E2 | | |
| 60 | E2 | | |
| 61 | E2 | CBE Scores for Comparison - (Smallest vaue is winner) | |
| 62 | E2 | [symbol] Sr [symbol] | EDV with C & R only |
| 63 | E2 | 1 | Proximity |
| 64 | E2 | 2 | [symbol] |
| 65 | E2 | 3 | [symbol] |
| 66 | E2 | 4 | [symbol] |
| 67 | E2 | 5 | [symbol] |
| 68 | | Std & Pre- [symbol] CBE med [symbol] | The [symbol] value will be somewhere in between |
| | | | ( [symbol] to be [symbol] ) |
| 69 | | | Cost |
| 70 | | | Rating |
| 71 | | | Urgency |
| 72 | | | Proximity |
| 73 | | | |
| 74 | | | |

| | D |
|---|---|
| 39 | Urgency Factor UF = M ( [symbol] ): PF = L ( [symbol] ), R - 10 ( [symbol] ) |
| 40 | Job Description Tooth Ache |
| 41 | BE [symbol] Pro- [symbol] (CR = D, UF = M, PF = L) |
| 42 | Server |
| 43 | Sr # |
| 44 | |
| 45 | |
| 46 | 1 |
| 47 | 2 |
| 48 | 3 |
| 49 | 4 |
| 50 | 5 |
| 51 | Avg [symbol] >>> |
| 52 | |
| 53 | |
| 54 | |
| 55 | [symbol] |
| 56 | R1 |
| 57 | R2 |
| 58 | R3 |
| 59 | |
| 60 | |
| 61 | (Consider this an Effective Dollar Value) |
| 62 | UF: Urgency - [symbol] Site for an Urgent Appointment (time) |
| 63 | =(E51 + (E46-E51) [symbol] F [symbol] /100 [symbol] E51 [symbol] (G45-G51)/G51 [symbol] (100-F56)/100) [symbol] (F57/100 [symbol] (F57-(100-F57)/100 [symbol] H46/H52) |
| 64 | =(E51 + (E47-E51) [symbol] F [symbol] /100 [symbol] E51 [symbol] (G47-G51)/G51 [symbol] (100-F56)/100) [symbol] (F57/100-(F57 [symbol] (100-F57)/100 [symbol] H47/H52) |
| 65 | =(E51 + (E48-E51) [symbol] F [symbol] /100 [symbol] E51 [symbol] (G48-G51)/G51 [symbol] (100-F56)/100) [symbol] (F57/100-(F57 [symbol] (100-F57)/100 [symbol] H48/H52) |
| 66 | =(E51 + (E49-E51) [symbol] F [symbol] /100 [symbol] E51 [symbol] (G49-G51)/G51 [symbol] (100-F56)/100) [symbol] (F57/100-(F57 [symbol] (100-F57)/100 [symbol] H49/H52) |
| 67 | =(E51 + (E50-E51) [symbol] F [symbol] /100 [symbol] E51 [symbol] (G50-G51)/G51 [symbol] (100-F56)/100) [symbol] (F57/100-(F57 [symbol] (100-F57)/100 [symbol] H50/H52) |
| 68 | Min (N) |
| 69 | 100 |
| 70 | 0 |
| 71 | 50 |
| 72 | 50 |
| 73 | |
| 74 | |
| | E |
| 39 | |
| 40 | |
| 41 | |
| 42 | Provider |
| 43 | |
| 44 | [symbol] |
| 45 | |
| 46 | [symbol] 10 |
| 47 | 1 [symbol] |
| 48 | 110 |
| 49 | 125 |
| 50 | 120 |
| 51 | [symbol] AVERAGE [symbol] |
| 52 | |
| 53 | |
| 54 | |
| 55 | |
| 56 | |
| 57 | |
| 58 | |
| 59 | |
| 60 | |
| 61 | |
| 62 | PF: Proximity [symbol] Provider [symbol] |
| 63 | =(E51 + (E46-E51) [symbol] F [symbol] /100 [symbol] E51 [symbol] (G46-G51)/G51 [symbol] (100 [symbol] F56)/100) [symbol] (F58/100 + (F [symbol] (100-F [symbol] )/100 [symbol] 46/ [symbol] 52) |
| 64 | =(E51 + (E47-E51) [symbol] F [symbol] /100 [symbol] E51 [symbol] (G47-G51)/G51 [symbol] (100 [symbol] F56)/100) [symbol] (F58/100 + (F [symbol] (100-F [symbol] )/100 [symbol] 47/ [symbol] 52) |
| 65 | =(E51 + (E48-E51) [symbol] F [symbol] /100 [symbol] E51 [symbol] (G48-G51)/G51 [symbol] (100 [symbol] F56)/100) [symbol] (F58/100 + (F [symbol] (100-F [symbol] )/100 [symbol] 48/ [symbol] 52) |
| 66 | =(E51 + (E49-E51) [symbol] F [symbol] /100 [symbol] E51 [symbol] (G49-G51)/G51 [symbol] (100 [symbol] F56)/100) [symbol] (F58/100 + (F [symbol] (100-F [symbol] )/100 [symbol] 49/ [symbol] 52) |
| 67 | =(E51 + (E50-E51) [symbol] F [symbol] /100 [symbol] E51 [symbol] (G50-G51)/G51 [symbol] (100 [symbol] F56)/100) [symbol] (F58/100 + (F [symbol] (100-F [symbol] )/100 [symbol] 50/ [symbol] 52) |
| 68 | Low (L) |
| 69 | 80 |
| 70 | 20 |
| 71 | 60 |
| 72 | 60 |
| 73 | |
| 74 | |

[symbol]

indicates data missing or illegible when filed

APPENDIX C

[symbol]

| 4 | CBE | data given | Server | Provider | Server | Server | Server | Provider | | |
|---|---|---|---|---|---|---|---|---|---|---|
| | opera- | by ---->>> | | | | | | | | |
| | tion | | | | | | | | | |
| 5 | | | Bidder | Bid | Bidder | Delay | Proximity | TOA/ETA | | |
| | | | Sr # | Amount | | (Mins) | | | | |
| 6 | | Max 4 Parameters: | | $ | Q-Rating | dT | (Km)/Trav | Hrs | | |
| | | $, Q (Rating), | | | | | time | | | |
| | | Urgency, Proximity | | | | | | | | |
| 7 | | (call-Request at | | | | (Ta − | | Ta | | |
| | | 0900 hrs) = On | | | | Ts) | | | | |
| | | site from (Ts) 0930 hrs | | | | | | | | |
| 8 | | Urgent = | 1 | 185 | 7 | 120 | 2.8 | 11: [symbol] | | |
| | | (latest TOA = | | | | | | | | |
| | | TOC/Resp DL + 4 Hr) | | | | | | | | |
| 9 | | ASAP: 0.5 Hr-4 | 2 | 180 | 6 | 150 | 9.0 | [symbol] | | |
| | | hr window | | | | | | | | |
| | | (no urgency) | | | | | | | | |
| 10 | | Bidder Rating T23 | 3 | 175 | 7 | [symbol] | 8.5 | 11:00 | | |
| | | (Top two-thirds) | | | | | | | | |
| 11 | | Default CBE - CR | 4 | 170 | 6 | 210 | 7.4 | [symbol] | | |
| | | (rating) = 50 | | | | | | | | |
| 12 | NH | Depends on user | 5 | 165 | 6 | 60 | 4.1 | 10: [symbol] | | |
| | (gren) | input, pocessed by | | | | | | | | |
| | | the machine (server) | | | | | | | | |
| 13 | 115 | These numbers | Avg >> | 175.0 | 6.4 | 126 | 6.4 | | | |
| | (blue) | are selected | | | | | | | | |
| | | by user/provider | | | | | | | | |
| 14 | 121 | The average values | | Default | User | 240 | 10 | << Radius Km | | 240 = Urgency |
| | | from the bids | | When | assigned | | | or Travel time | | Window |
| | | (server output) | | applicable | Weights | | | (for Proximity) | | (Mins) |
| 15 | CR | $-Q Weightage | R1 | Def = 50% | 65 | <<< Weightage | | | | |
| | Balance | (Range 100 > X1 > 0%) | | | | Options | | | | |
| 16 | Urg | Urgency Weightage | R2 | Def = 75% | 50 | <<< Weightage | | | No weight | |
| | (E-L) | (Range 100 > X2 > 50%) | | | | Options (≦50) | | | at 50 | |
| 17 | Prox | Proximity Weightage | R3 | Def = 75% | 50 | <<< Weightage | | | No weight | |
| | (N-F) | (100 > X3 > 50%) | | | | Options (≦50) | | | at 50 | |
| 18 | Bid | Score for Comparison - | | | | Min (H) | Low (L) | Med (M) | High (H) | Max (X) |
| | Sr # | (Smallest value | | | | | | | | |
| | | is winner) | | | | | | | | |
| 19 | | | | | | Cheapest | cheaper | fair | better [symbol] Q | Top [symbol] Q |
| | | | | | | | | balance | | |
| 20 | | (Consider this an | | Actual BIDS | | 100 | [symbol] | 65 | 30 | 0 |
| | | Effective Dollar | | | | | | | | |
| | | Value - EDV) | | | | | | | | |
| 21 | Bid | Bids: (Numerical) | Linearized | Temp (Store) | QUALITY | 85 | 15 | 35 | 70 | 100 |
| | Sr # | Value, EDV | (Normalized) | while playing | Q-F COST | | | | | |
| | | | Lowest = 1 | with the Auto- | | | | | | |
| | | | Highest = 10 | Pick Formula | | | | | | |
| 22 | 1 | 43.94 | 5.56 | [symbol] | UF (min) | 50 | 60 | 75 | [symbol] | 100 |
| 23 | 2 | 45.52 | 10.00 | [symbol] | PF (Min) | 50 | 60 | 75 | [symbol] | 100 |
| 24 | 3 | 42.31 | 1.00 | 175 | Default Level | | | | | |
| 25 | 4 | 43.80 | 5.44 | 170 | | | | | | |
| 26 | 5 | 43.08 | 3.16 | 165 | | | | | | |
| 27 | | | | | | | | | | |
| 28 | | The five levels | Min (N) | Low (L) | Med (M) | High (H) | Max (X) | | | |
| | | of weights: The | | | | | | | | |
| | | default value will | | | | | | | | |
| | | be somewhere in | | | | | | | | |
| | | between (best fit | | | | | | | | |
| | | by trail & error) | | | | | | | | |
| 29 | Q-F | Cost | 100 | 75 | 60 | 25 | 0 | | | |
| 30 | UF | Rating | 0 | 25 | 40 | 75 | 100 | | | |
| 31 | PF | Urgency | 50 | 60 | 75 | 90 | 100 | | | |
| 32 | | Proximity | 50 | 60 | 75 | 90 | 100 | | | |

Default values for sample

| | | | | | | | |
|---|---|---|---|---|---|---|---|
| $ | 205 | 7.2 | Q | T | 120 | 2.8 | P |
| | 190 | 6.6 | | Time (delay) | 150 | 9.0 | Prox |
| | 175 | 6 | | | 90 | 8.5 | |
| | 160 | 5.4 | | | 210 | 7.4 | |
| | 145 | 4.8 | | | 60 | 4.1 | |

| $ Range | | | | | Q-Range | | | | |
|---|---|---|---|---|---|---|---|---|---|
| Wide | $ | $ | $ | Narrow | Wide | | | | Narrow |
| 235 | 220 | 205 | 190 | 175 | 8 | 7.6 | 7.2 | 6.8 | 6.4 |
| 210 | 200 | 190 | 180 | 170 | 7 | 6.8 | 6.6 | 6.4 | 6.2 |
| 185 | 180 | 175 | 170 | 165 | 6 | 6 | 6 | 6 | 6 |
| 160 | 160 | 160 | 160 | 160 | 5 | 5.2 | 5.4 | 5.6 | 5.8 |
| 135 | 140 | 145 | 150 | 155 | 4 | 4.4 | 4.8 | 5.2 | 5.6 |
| 25 | 20 | 15 | 10 | 5 | 1 | 0.8 | 0.6 | 0.4 | 0.2 |

[symbol]

indicates data missing or illegible when filed

1) A computer implemented distributed purchasing system, said system comprising;
a computer executable program providing for logical selection of the best suitable bid among a plurality of bids for a commercial transaction;
a database of users connected communicatively over an internet network to the said program, said users being either among requesters and providers;
a memory device for storing said program and said database of users;
processor means for executing said program;
a user interface for anonymous communication between said users; and
communication network for linking requestors and providers corresponding to best suitable bid for enabling execution of sought commercial transaction, said communication network comprising communications means chosen among the group of internet, mobile phones, call centers and the like.
a broadcasting system for conveying request descriptions to population of providers over said communications network and enabling communication between providers and requestors for completion of the purchase transaction.

2) A computer implemented distributed purchasing system according to claim 1 wherein at least one of the requester and provider are registered members of the service provided by the GSPP portal

3) A computer implemented distributed purchasing system according to claim 1 wherein the said computer executable program comprises;
code for submitting by the requestor a job description to the GSPP portal, said job description being qualified by user-selectable filters among cost, urgency, quality, tenure of job, performance rating and proximity of delivery;
code for broadcasting by the GSPP portal a substantially simultaneous invitation based upon the said job description to a population of providers over a communications network;
code for communication by responding providers the corresponding bids to the said GSPP portal;
code for ranking the bids according to the job description, said job description being qualified by user-specified values of parameters of quality, urgency, cost and provider rating;
code for selecting the best suitable bid and provider according to the ranking of the said bids; and
code for issuance of information to the requestor and provider of the selected bid for successful completion of the purchase transaction.

4) A method for logical selection of the best suitable bid among a plurality of bids for a commercial transaction, said method comprising the steps of:
submission to the GSPP portal by the requestor a job description qualified by user-selectable filters among cost, urgency, quality, tenure of job, rating of provider and proximity of delivery;
sending of invitation over a communications network to said job description by the GSPP portal to providers satisfying the said user-selectable filters;
receiving by the GSPP portal quotation bids in respect of the said job descriptions from at least some of the contacted providers;
ranking of bids on basis of suitability criteria between bids and job descriptions, said suitability criteria comprising extent of identity of job description with received bid and performance rating of bidders obtained from information of prior transactions stored by the GSPP portal about the respective bidders;
checking with the scheduler for availability and ability of the top ranked bidder to execute the transaction; and
sending by the GSPP portal alerts to requester and available top ranked bidder for completion of transaction of the best suitable bid.

5) A computer implemented distributed purchasing system according to claim 1 substantially as described herein with reference to the accompanying description and drawings.
